(19) United States
(12) Patent Application Publication
(10) Pub. No.: US 2008/0039160 A1
(43) Pub. Date: Feb. 14, 2008

(54) Wireless communications interface for a portable electronic device

(76) Inventors: Steven S. Homer, Houston, TX (US); Paul J. Doczy, Houston, TX (US); Timothy Neill, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/491,431

(22) Filed: Jul. 21, 2006

(51) Int. Cl. H04B 1/06; H04M 1/00; H04B 7/00

(52) U.S. Cl. 455/575.7; 455/272

(57) ABSTRACT

A portable electronic device comprises an interface configured to, in response to detecting releasable engagement of an external antenna to the electronic device, switch from using an internal antenna to the external antenna for the wireless communications.

### BACKGROUND OF THE INVENTION

The amount of space within a portable electronic device generally limits the size and/or performance characteristics of an internally disposed antenna (e.g., for wireless communications). For example, because of space limitations and the locations of other components within the electronic device, the antenna is generally not sized, located or oriented to provide optimal wireless communications in different operating environments and/or different types of wireless networks.

### BRIEF DESCRIPTION OF THE DRAWINGS

For a more complete understanding of the present invention and the advantages thereof, reference is now made to the following descriptions taken in connection with the accompanying drawings in which:

FIG. 1 is a diagram illustrating a portable electronic device in which an embodiment of a wireless communications interface in accordance with the present invention is employed to advantage;

FIG. 2 is a diagram illustrating another device in which an embodiment of a wireless communications interface in accordance with the present invention is employed to advantage; and

FIG. 3 is a block diagram illustrating an embodiment of a wireless communications interface in accordance with the present invention.

### DETAILED DESCRIPTION OF THE DRAWINGS

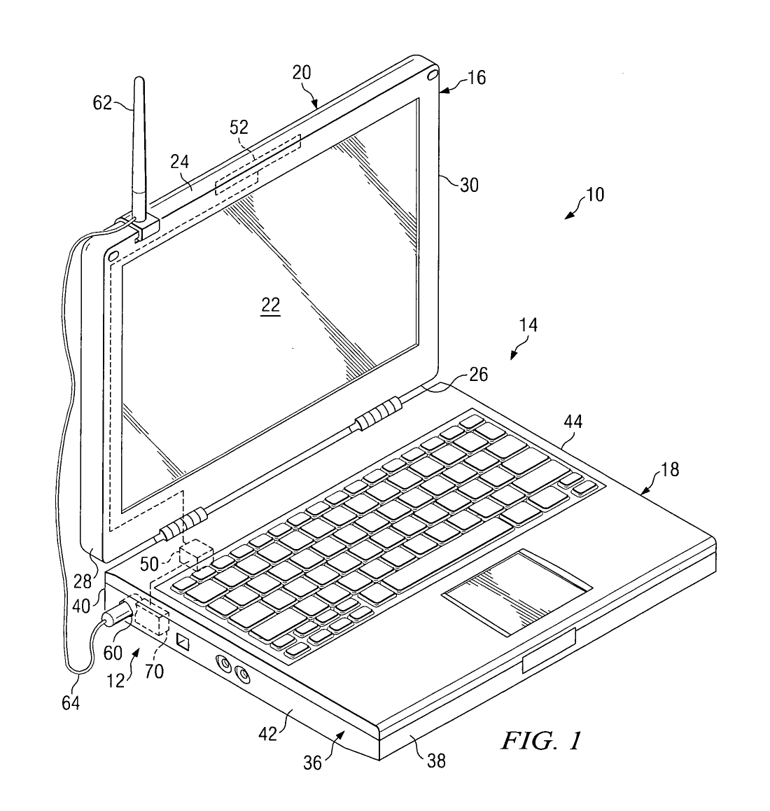

The preferred embodiments of the present invention and the advantages thereof are best understood by referring to FIGS. 1-3 of the drawings, like numerals being used for like and corresponding parts of the various drawings.

FIG. 1 is a diagram illustrating a portable electronic device 10 in which an embodiment of a wireless communications interface 12 in accordance with the present invention is employed to advantage. In the embodiment illustrated in FIG. 1, electronic device 10 comprises a laptop or notebook computer 14 having a display member 16 rotatably coupled to a base member 18. However, it should be understood that embodiments of wireless communications interface 12 in accordance with the present invention may be employed to advantage in a variety of different types of portable electronic devices 10 such as, but not limited to, a tablet computer, a convertible portable computer, a cellular telephone, a personal digital assistant or other type of portable computing device.

In the embodiment illustrated in FIG. 1, display member 16 comprises a housing 20 for supporting a display screen 22 having an upper wall 24, a lower wall 26, and sidewalls 28 and 30. In FIG. 1, base member 18 comprises a housing 36 having a front wall 38, a rear wall 40, and sidewalls 42 and 44. In the embodiment illustrated in FIG. 1, electronic device 10 comprises a wireless module 50 for enabling wireless communications by electronic device 10. Wireless module 50 may comprise hardware, software, firmware, or a combination thereof. Wireless module 50 may comprise an integrated wireless electronic card, a mini-card coupled to a motherboard disposed within electronic device 10, or any other type of module for facilitating and/or otherwise enabling wireless communications by electronic device 10. In the embodiment illustrated in FIG. 1, a single wireless module 50 is illustrated. However, it should be understood that electronic device 10 may be configured having multiple wireless modules 50. In FIG. 1, wireless module 50 is illustrated as being disposed within base member 18. However, it should be understood that wireless module 50 may be otherwise located within electronic device 10.

In FIG. 1, electronic device 10 is configured having an internal antenna 52 communicatively coupled to wireless module 50. In FIG. 1, internal antenna 52 is illustrated as being disposed within display member 16. However, it should be understood that internal antenna 52 may be otherwise located within electronic device 10. In the embodiment illustrated in FIG. 1, interface 12 comprises an input/output port 60 for receiving an external antenna 62 communicatively coupled thereto (e.g., via a cable 64). In FIG. 1, input/output port 60 is illustrated as being disposed in and/or extending through sidewall 42 of housing 36. However, it should be understood that input/output port 60 may be otherwise located on electronic device 10 (e.g., on front wall 38, rear wall 40, or sidewall 42 of housing 36 and/or in housing 20 of display member 16). Input/output port 60 is communicatively coupled to wireless module 50 to enable and/or otherwise facilitate wireless communications by electronic device 10 using external antenna 62. Preferably, input/output port 60 is configured as an integral component of electronic device 10 (i.e., configured as a permanent or hard-wired component of base member 18). Wireless module 50 and/or antennas 52 and 62 may be configured for wireless communications for a wide area network (WAN), local area network (LAN), or various other types of wireless communication bands or frequencies, including communications across various frequency bands or spectrums.

In the embodiment illustrated in FIG. 1, interface 12 also comprises a controller 70 for sensing and/or otherwise detecting engagement and disengagement of external antenna 62 to input/output port 60. In some embodiments of the present invention, controller 70 is also used to automatically switch between using internal antenna 52 and external antenna 62 for wireless communications by electronic device 10. Controller 70 may comprise hardware, software, firmware, or a combination thereof.

In operation, in some embodiments of the present invention, if external antenna 62 is engaged and/or otherwise coupled to input/output port 60, or in response to detecting engagement of external antenna 62 with input/output port 60, controller 70 communicates with and/or otherwise causes wireless module 50 to automatically switch from using internal antenna 52 to using external antenna 62 for wireless communications. Correspondingly, if external antenna 62 is not coupled to input/output port 60, electronic device 10 is configured to continue to use internal antenna 52 for wireless communications. Further, in some embodiments of the present invention, in response to detecting and/or otherwise determining a disengagement of external antenna 62 from input/output port 60, controller 70 communicates with and/or otherwise causes wireless module 50 to automatically switch from using external antenna 62 to using internal antenna 52 for wireless communications. It should be understood that in some embodiments of the present invention, toggling and/or switching between external antenna 62 and internal antenna 52 may be performed manually (e.g., as a means to override an automatic antenna selection and/or to enable a user to manually select a particular antenna).

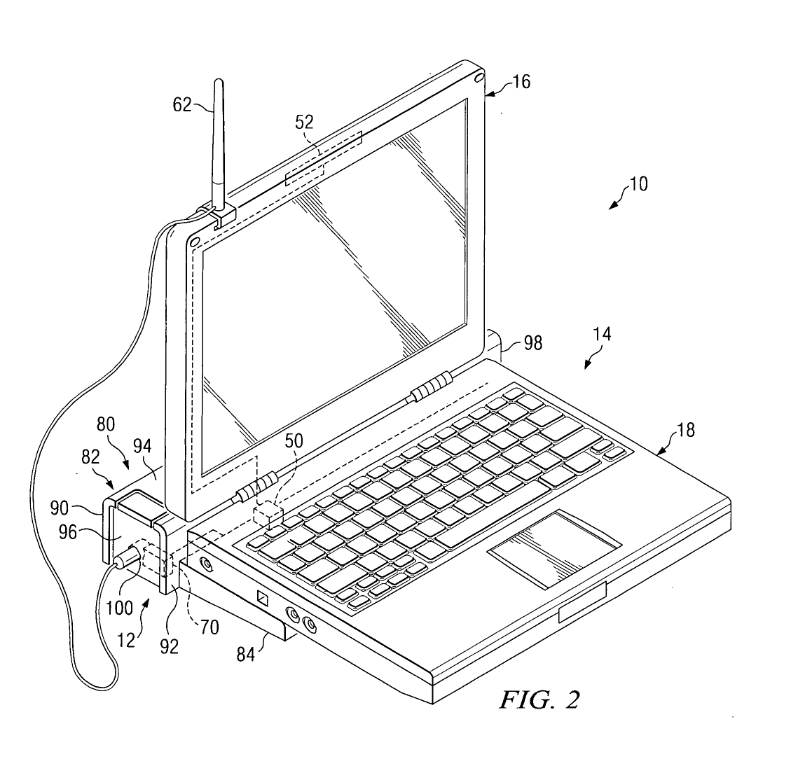

FIG. 2 is a diagram illustrating another electronic device 80 in which an embodiment of wireless communications interface 12 in accordance with the present invention is employed to advantage. In the embodiment illustrated in FIG. 2, electronic device 80 comprises a docking station 82 for receiving releaseable engagement and/or coupling thereto of electronic device 10. In FIG. 1, docking station 82 comprises a base member 84 which is preferably configured to physically and/or communicatively couple to electronic device 10 to facilitate power, data and/or other types of signals to be communicated between docking station 82 and electronic device 10.

In the embodiment illustrated in FIG. 2, docking station 82 comprises a rear wall 90, a front wall 92, an upper wall 94, and sidewalls 96 and 98. In the embodiment illustrated in FIG. 2, wireless interface 12 comprises an input/output port 100 disposed in sidewall 96 of docking station 82 for receiving releaseable engagement therewith of external antenna 62. However, it should be understood that input/output port 100 may be otherwise located on docking station 82. Further, in the embodiment illustrated in FIG. 2, controller 70 is illustrated as being disposed in docking station 82. However, it should be understood that controller 70 may be disposed within electronic device 10 and used in connection with docking station 82. Preferably, input/output port 100 is configured as an integral component of docking station 82 (i.e., configured as a permanent or hard-wired component of docking station 82).

In operation, wireless interface 12 is used to sense and/or otherwise detect engagement of external antenna 62 with input/output port 100. Additionally, in some embodiments of the present invention, wireless interface 12 is configured to automatically switch between internal antenna 52 and external antenna 62 for wireless communications by electronic device 10 based on whether external antenna 62 is coupled to docking station 82. For example, in some embodiments of the present invention, in response to docking of electronic device 10 with docking station 82, controller 70 detects and/or otherwise determines whether external antenna 62 is engaged with input/output port 100. If external antenna 62 is engaged and/or otherwise coupled to input/output port 100, controller 70 communicates with and/or otherwise causes wireless module 50 to switch from using internal antenna 52 to using external antenna 62 for wireless communications. Correspondingly, if external antenna 62 is not coupled to input/output port 100, electronic device 10 continues to use internal antenna 52 for wireless communications. Further, in some embodiments of the present invention, in response to detecting and/or otherwise determining a disengagement of external antenna 62 from input/output port 100, controller 70 communicates with and/or otherwise wireless module 50 to switch from using external antenna 62 to using internal antenna 52 for wireless communications.

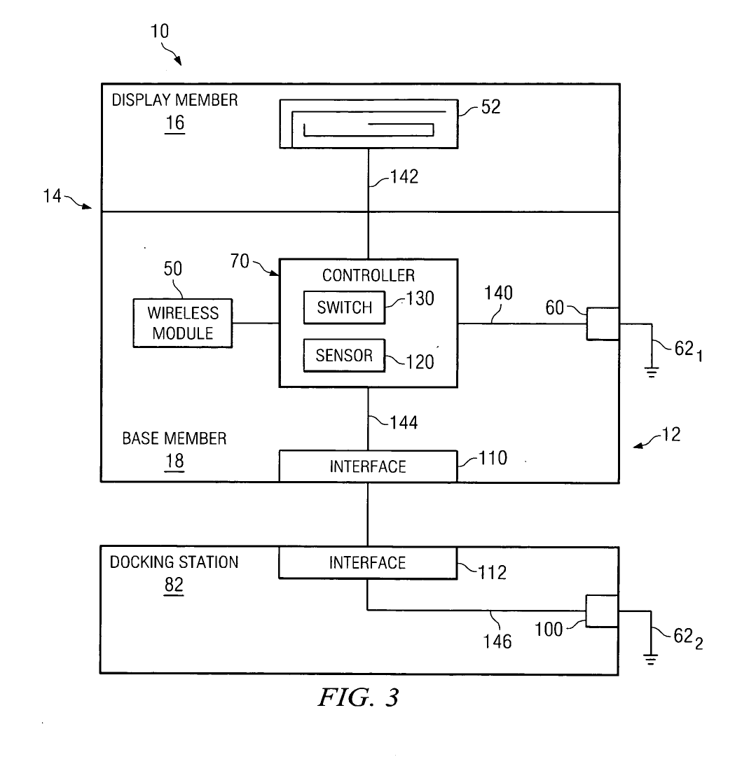

FIG. 3 is a block diagram illustrating an embodiment of wireless interface 12 in accordance with the present invention. In FIG. 3, electronic device 10 comprises an interface 110 for communicatively and/or physically engaging a corresponding interface 112 disposed on docking station 82. Interfaces 110 and 112 may comprise a connector. However, it should be understood that other types of engagement mechanisms may be used for coupling electronic device 10 to docking station 82. It should also be understood that electronic device 10 may be “coupled” to docking station 82 via a wireless connection.

In FIG. 3, electronic device 10 is illustrated as being coupled to docking station 82. However, it should be understood that embodiments of the present invention may be used solely with electronic device 10 (e.g., independently of docking station 82) and/or used in combination with docking station 82. In the embodiment illustrated in FIG. 3, controller 70 is illustrated as being disposed in electronic device 10. However, it should be understood that, additionally or alternatively, one or more elements and/or functions of controller 70 may be disposed in docking station 82. Further, in FIG. 3, controller 70 is illustrated as being a separate component apart from wireless module 50. However, it should be understood that one or more elements and/or functions of controller 70 may be integrated with and/or otherwise form a part of wireless module 50. Additionally, in FIG. 3, input/output ports 60 and 100 and internal antenna 52 are illustrated as being coupled directly to controller 70. However, it should be understood that input/output ports 60 and 100 and/or internal antenna 52 may be coupled directly to wireless module 50 (e.g., coupled directly to coaxial connectors forming part of module 50).

In the embodiment illustrated in FIG. 3, controller 70 comprises a sensor 120 and a switch 130. Sensor 120 may comprise any type of electrically-based and/or mechanically-based detection element for sensing and/or otherwise detecting engagement of external antenna 62 to electronic device 10 and/or docking station 82 (e.g., external antennas 62, and 622 as illustrated in FIG. 3). Switch 130 may comprise any type of switching element for switching between external antenna 62 and internal antenna 52 for wireless communications by electronic device 10. For example, in the embodiment illustrated in FIG. 3, switch 130 (via controller 70) is coupled to input/output port 60 via a conduit or cable 140 and internal antenna 52 via a conduit or cable 142. Additionally, switch 130 (via controller 70) is coupled to input/output port 100 via conduit or cable 144 disposed within electronic device 10 and a conduit or cable 146 disposed within docking station 82.

In operation, wireless interface 12 is configured to automatically control use of either internal antenna 52 or external antenna 62 for wireless communications based on whether external antenna 62 is coupled to electronic device 10 (e.g., via input/output port 60 or via input/output port 100 when electronic device 10 is docked in docking station 82). Thus, for example, in response to sensor 120 detecting and/or otherwise determining that external antenna 62 is coupled to electronic device 10, switch 130 is automatically actuated, if necessary (e.g., if wireless communications are currently being processed using internal antenna 52), to switch from using internal antenna 52 to external antenna 62 for wireless communications. Correspondingly, in response to sensor 120 detecting disengagement of external antenna 62 from electronic device 10 (e.g., disengagement of external antenna 62, from input/output port 60 or disengagement of external antenna. 622 from input/output port 100 while electronic device is docked in docking station 82), switch 130 is automatically actuated to switch from using external antenna 62 to using internal antenna 52 for wireless communications.

Thus, embodiments of the present invention provide an input/output port 60, 100 specially configured for attaching an external antenna thereto to facilitate enhanced wireless communications for electronic device 10. For example, external antenna 62 is generally configured having greater performance capabilities than internal antenna 52 (e.g., because of size and/or space constraints for internal antenna 52 within electronic device 10). Thus, for example, if a user of electronic device desires to connect to a wireless network that internal antenna 52 would be otherwise unable to support (e.g., a cellular telephone network where internal antenna 52 is either not suited and/or otherwise unable to effectively communicate with such network), external antenna 62 may be coupled to electronic device 10 (e.g., to input/output port 60 and/or to input/output port 100 of docking station 82) such that external antenna 62 is used in combination with wireless module 50 for the desired wireless communications and/or network. Further, embodiments of the present invention are configured to automatically use an antenna coupled to electronic device 10 having the greater performance capabilities (e.g., external antenna 62 compared to internal 52).

What is claimed is:

1. A portable electronic device, comprising:
an interface configured to, in response to detecting releasable engagement of an external antenna to the electronic device, switch from using an internal antenna to the external antenna for wireless communications.

2. The system of claim 1, wherein the interface comprises an input/output port for coupling the external antenna to the electronic device.

3. The system of claim 1, wherein the interface comprises an input/output port disposed in a housing of the electronic device.

4. The system of claim 1, wherein the interface comprises a sensor configured to detect the external antenna coupled to the electronic device.

5. The system of claim 1, wherein the interface is configured to detect coupling of the external antenna to the electronic device via a docking station.

6. The system of claim 1, wherein the interface is configured to detect disengagement of the external antenna from the electronic device.

7. The system of claim 1, wherein the interface is configured to, in response to detecting disengagement of the external antenna from the electronic device, switch from using the external antenna to the internal antenna for the wireless communications.

8. The system of claim 1, wherein the electronic device comprises a portable computer.

9. The system of claim 1, wherein the interface is configured to automatically switch from using the internal antenna to the external antenna.

10. A portable electronic device, comprising:
means for, in response to detecting releasable engagement of an external antenna means to the electronic device, switching from an internal antenna means to the external antenna means for wireless communications.

11. The system of claim 10, wherein the means for switching comprises means for, in response to detecting disengagement of the external antenna means from the electronic device, switching from the external antenna means to the internal antenna means for the wireless communications.

12. The system of claim 10, further comprising means for detecting coupling of the external antenna means to the electronic device via a docking means.

13. The system of claim 10, further comprising means for detecting coupling of the external antenna means to the electronic device.

14. The system of claim 10, further comprising means disposed through a housing means of the electronic device for coupling the external antenna means to the electronic device.

15. A method for wireless communications, comprising:
automatically switching from an internal antenna to an external antenna for wireless communications of the portable electronic device in response to detecting releasable engagement of the external antenna to the portable electronic device.

16. The method of claim 15, further comprising detecting disengagement of the external antenna from the portable electronic device.

17. The method of claim 15, further comprising automatically switching to the internal antenna from the external antenna for wireless communications in response to detecting disengagement of the external antenna from the portable electronic device.

18. The method of claim 15, further comprising detecting engagement of the external antenna to the portable electronic device via a docking station.

19. The method of claim 15, further comprising detecting disengagement of the external antenna to the portable electronic device via a docking station.

20. A wireless communications interface, comprising:
a docking station configured to receive a portable electronic device releasably coupled thereto, the docking station configured to receive an external antenna releasably coupled thereto for enabling wireless communications by the portable electronic device using the external antenna when the portable electronic device is coupled to the docking station.

21. The interface of claim 20, wherein the docking station comprises an input/output port for receiving releasable coupling of the external antenna.

22. The interface of claim 20, wherein the docking station comprises an input/output port disposed through a housing of the docking station for receiving releasable coupling of the external antenna.
